(19) United States
(12) Patent Application Publication
(10) Pub. No.: US 2019/0300281 A1
(43) Pub. Date: Oct. 3, 2019

(54) WEIGHTED LID FOR A TRASH CONTAINER

(71) Applicant: Frederick Thomas Strobl, Wayzata, MN (US)

(72) Inventor: Frederick Thomas Strobl, Wayzata, MN (US)

(21) Appl. No.: 15/942,546

(22) Filed: Apr. 1, 2018

(51) Int. Cl. B65F 1/16; B65F 1/14

(52) U.S. Cl. CPC B65F 1/1646; B65F 2250/1143; B65F 2001/1653; B65F 1/1473

(57) ABSTRACT

Weight attached to distal side of trash container lid with fastener without protruding outside outer edge of the lid prevents opening by wind or small animals, eliminating interference with automated systems for container emptying and for manual lid disengagement before the container is turned bottom up for emptying.

### BACKGROUND OF THE INVENTION

The problem of the unintended detachment of trash container lids by wind or by small animals is well known and universal for containers manufactured with light-weight lids made of thermoplastics such as polypropylene or polyethylene. When can lid is blown open or opened by an animal, the container is often knocked over, trash may be spilled out, an eyesore and health hazard may be created. Trash recovery after such a spill my require time, effort and, sometimes, significant expense.

Securing a lid to a garbage container may be achieved using a retaining strap, a clip, a spring-loaded device securing the lid to the container body. A general drawback of the existing solution is that they interfere with automated systems for container emptying into a trash collecting truck by requiring manual lid disengagement before the container is turned bottom up for emptying. Importantly, they are often complex systems subject to performance failure, especially during emptying.

### BRIEF SUMMARY OF THE INVENTION

The present disclosure prevents unintended detachment of a trash container lid by wind or small animals without interfering with automated systems for container emptying into a trash collecting truck. A weight is attached to a distal end of the lid in a manner that eliminates the need for manal lid disengagement before the container is turned bottom up for emptying, and greatly reduced the probability of the automated system performance failure.

### BRIEF DESCRIPTION OF THE DRAWINGS

There are shown in the drawings embodiments which are presently preferred it being understood, however, that the invention is not limited to the precise arrangements and instrumentalities shown, wherein:

FIGS. 1A and 1B are respectively a perspective view of a lid according to the disclosure attached to a trash container, and a cross section of the lid taken along the line 1-1′ shown in FIG. 1A.

FIGS. 2A, 2B and 2C are cross-sections of a first lid configuration, a second lid configuration and a third lid configuration respectively.

### DETAILED DESCRIPTION OF THE INVENTION

A trash container lid covers the top of a generally rectangular trash container.

The trash container lid has a generally flat top connected to the container with a hinge attached to the lid at a proximate side. The hinge has a rotation axis around which the lid rotates when opened for depositing trash into the container or for emptying the container into the trash collecting truck.

The lid has a distal side, opposite the proximate side, and a distal point, the distal point being the point on the lid which is farthest removed from the rotation axis.

A weigh is attached to the lid adjacent the distal side in such a manner that the farthest point of the weight is positioned closer to the axis than the distal point of the lid.

The weight may be prepared of any high-density material, including but not limited to cast iron, metal shot, sand, concrete, or fluid adapted to be attached at the distal end of the lid in a manner adapted to provide sufficient moment of force to prevent the lid opening by wind gusts or by small animals. The moment of force is determined by a product of the total weight of the lid by the distance between its center of mass and the rotation axis defined by the hinge.

In one aspect of this disclosure, the lid is prepared with a pocket adapted to receive and contain the weight. It may be either molded with the lid as a single monolithic shape with the pocket defined, or the pocket can be attached to the system. In this case, the weight is inserted into the pocket.

In another aspect of the disclosure, the weight is mechanically fastened to the lid. The means for such mechanical fastening may be selected from but not limited to rivets, screws, spring clips, snap fits, metal inserts or hot staking.

In yet another aspect of the disclosure, the weight is joined to the lid through adhesive bonding or welding. For joining, the weight would preferably, though not necessarily, be configured with a surface of the same material as the lid, i.e. polypropylene if the lid is made of polypropylene; if the lid is made of polyethylene, the weight would preferably manufactured with a polyethylene surface for joining to the lid.

Adhesive bonding offers the potential for joining any two materials. Therefore, in this aspect of the invention the weight may be prepared without a surface of the same thermoplastic which the container lid is made of.

Adhesives can be classified into two broad categories: 1) Two-component systems, in which the two components are mixed just prior to use. The two components react chemically during the cure cycle, resulting in the desired bond. 2) Single component systems. The most commonly used structural adhesives are epoxies, urethanes and acrylics-which are two-component systems- and the single-component class comprising cyanoacrylates, anaerobics, and hot melts.

Epoxies represent the most widely used class of versatile adhesives. The two components are mixed, in equal measure, prior to use. Epoxies require long cures, or cycle times, that can be reduced by the application of heat. Epoxy bonds tend to be rigid and fail in a brittle manner. In contrast to epoxies, the two components of acrylic adhesives are not mixed before use. Rather, one component is applied to one surface, and the second component is applied to the second surface. The curing reaction occurs when the surfaces are mated. Cure times are shorter than for epoxies, and result in more flexible bonds.

Anaerobics are single-component adhesives that cure by oxygen deprivation. Cyanoacrylates, representative anaerobics, cure in seconds at room temperature.

In a further aspect of the present disclosure, thermoplastic surface of the weight may be joined to the thermoplastic surface of the lid by solvent bonding, welding, thermal bonding, friction welding, or electromagnetic bonding.

Solvent bonding only works for thermoplastics. In a representative basic solvent bonding process, the plastic surfaces to be joined are softened by using a layer of solvent. The parts are then clamped together under pressure, which allows polymer chains to diffuse across the joint interface. Evaporation of the solvent results in the desired bond. Cycle time is governed by the rate of solvent evaporation, and can be shortened by the use of heat. In some cases, solutions containing the plastic to be joined can be used instead of using pure solvents.

Welding requires a melting and subsequent freezing of the materials to be joined at the joint interface, it is only applicable to thermoplastic materials. Depending on how the heat for melting is supplied, welding can broadly be classified as 1) thermal bonding, comprising hot gas welding, extrusion welding, hot-tool (hot-plate) welding, and infrared heating, 2) friction (mechanical) welding, comprising spin welding, angular vibration welding, orbital welding, vibration welding, and ultrasonic welding, and 3) electromagnetic bonding, which includes resistance (implant) welding, induction welding, dielectric heating, and microwave heating.

In a stationary position, an upper lip of the trash container receptacle defines a plane disposed in a direction generally parallel to the ground. The lower lip of the lid is placed flat immediately adjacent the upper lip of the container receptacle.

Emptying a residential trash container involves 1) lifting it off the ground, 2) tipping it in a position wherein the can opening is placed above a garbage truck aperture, and the plane defined by its upper lip reaches a generally vertical position, at which point the hinged lid is rotated by the force of gravity acting upon it, and 4) tipping the trash can further to allow the force of gravity to dislodge trash from inside the container receptacle into the garbage truck aperture.

As the lid currently disclosed is separated from the receptacle, it swings open inside the garbage truck aperture. Attaching the weight to the lid adjacent its distal side in such a manner that the farthest point of the weight is positioned closer to the axis than the distal point of the lid, ensures that the weight does not interfere with either lid separation from the receptacle nor with it moving freely inside the truck aperture for efficient trash dislodging into the truck.

### DETAILED DESCRIPTION OF THE DRAWINGS

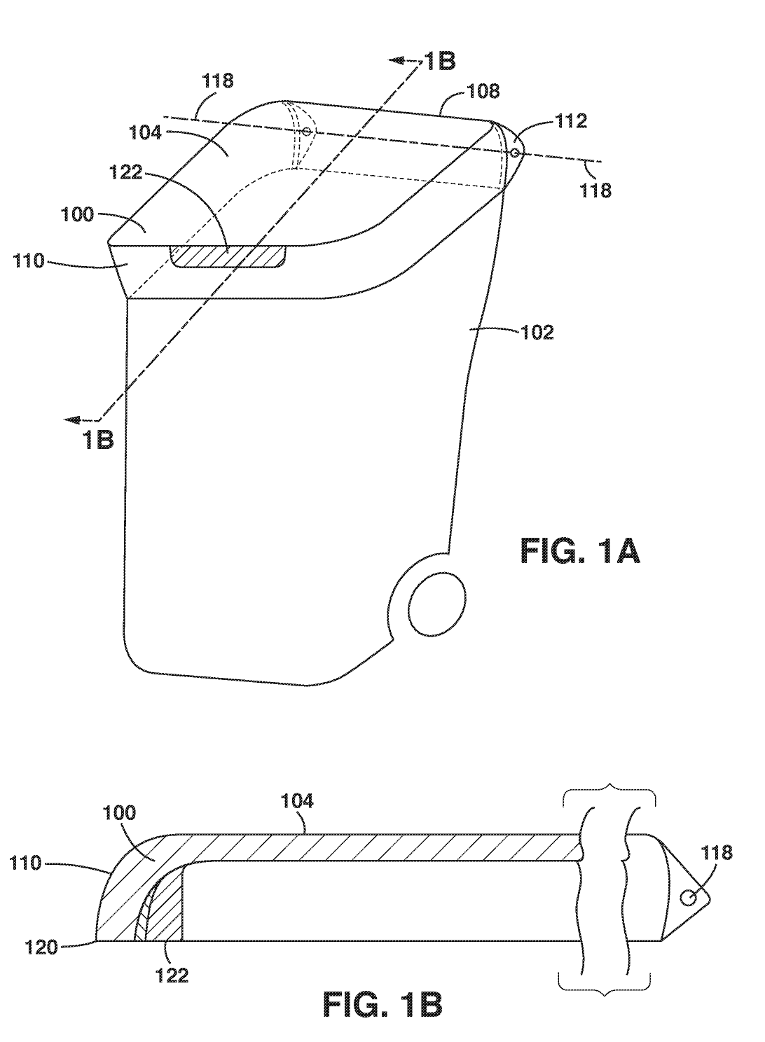

FIGS. 1A and 1B shows in detail a general arrangement of the lid 100 covering the top of a generally rectangular trash container 102.

The trash container lid 100 has a generally flat top 104 connected to the container 102 with a hinge 112 attached to the lid 100 at a proximate side 108. The hinge 112 has a rotation axis 118 around which the lid rotates when opened for depositing trash into the container or for emptying the container into the trash collecting truck.

The lid further has a distal side 110, opposite the proximate side 108, and a distal point 120, the distal point 120 being the point on the lid 100 which is farthest removed from the rotation axis 118.

A weight 122 is attached to the lid 100 adjacent the distal side 110 in such a manner that the farthest point of the weight 122 is positioned closer to the axis than the distal point of the lid 120.

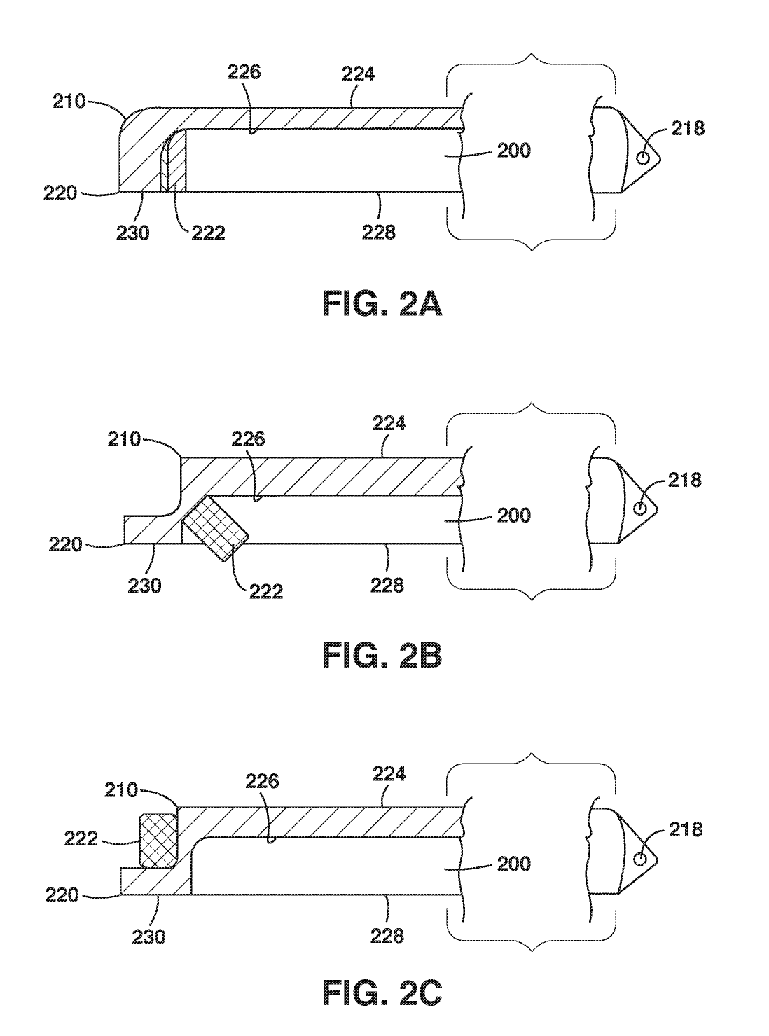

FIGS. 2A-2C show the first lid configuration, the second lid configuration and the third lid configuration respectively, wherein the lid 200 has a lower lip 230, an inward surface 226 of the distal side 210, facing inside the trash container 102 in a closed state, and an outward surface 224 opposite the inward surface.

In the first configuration shown in FIG. 2A, the weight 232 is attached to the inward surface 226 inside the envelope 228 defined by the lower lip 230. The weight is understood to be “inside” the envelope, when each point is located above the line 228 as shown in FIGS. 2A-2C.

In the second configuration shown in FIG. 2B, the weight 222 is attached to the inward surface 226, with at least some points of the weight 222 being located outside the envelope 228.

In the third configuration shown in FIG. 2C, the weight 222 is attached to the outward surface 224.

The three configurations shown in FIGS. 2A-2C are not intended to exhaust all possible arrangement, but represent mere examples of possibilities disclosed herein. In all configurations the weight 210 is preferably arranged to be placed in such a way that its each point is located closer to the axis 218 than the distal point 220. Thus, the weight 210 is placed to be fully inside the rotation trajectory 230 of the distal point 220 around rotation axis 218.

The attachment of the weight to the outward surface 224, the inward surface 226 or even a lip 230, may be achieved by any means of fastening disclosed above.

This invention can be embodied in other forms without departing from the spirit or essential attributes thereof, and accordingly, reference should be had to the following claims, rather than to the foregoing specification, as indicating the scope of the invention.

What is claimed is:

1. A trash container lid for covering a trash container, comprising:
a top,
a proximate side and a distal side, the proximate side connected to the trash container with a hinge, the hinge having a rotation axis around which the lid rotates when being open or closed;
a distal point being a point of the lid positioned at a maximum distance from the rotation axis;
a weight attached to the lid adjacent the distal side with a fastener, adapted to be positioned closer to the axis than the distal point.

2. The trash container lid of claim 1, wherein the fastener is an adhesive.

3. The trash container lid of claim 2, wherein the adhesive is a dispersion of solvent-type pressure-sensitive adhesives.

4. The trash container lid of claim 2, wherein the adhesive comprises a polyurethane contact adhesive.

5. The trash container lid of claim 2, wherein the adhesive is a two-part polyurethane adhesive.

6. The trash container lid of claim 2, wherein the adhesive is a vinyl acetate copolymer hot melt adhesive.

7. The trash container lid of claim 2, wherein the adhesive comprises an acrylic adhesive.

8. The trash container lid of claim 1, wherein the fastener is a double-sided adhesive tape.

9. The trash container lid of claim 1, wherein the lid is made of polyethylene.

10. The trash container lid of claim 1, wherein the lid is made of high-density polyethylene.

11. A method of retaining a lid on a trash container, the steps comprising:
providing a trash container comprising a lid, the lid comprising
a top;
an outer edge;
a proximate side and a distal side, the proximate side connected to the trash container with a hinge;
providing a weight attached to the lid adjacent the distal side with a fastener;
providing a lid weight comprising a weight and a fastener adapted for attaching the lid weight to the lid, wherein the geometrical dimensions of the weight do not project outside the outer edge of the lid.
